(19) United States
(12) Patent Application Publication
(10) Pub. No.: US 2005/0289329 A1
(43) Pub. Date: Dec. 29, 2005

(54) Conditional instruction for a single instruction, multiple data execution engine

(76) Inventors: Michael K. Dwyer, El Dorado Hills, CA (US); Hong Jiang, San Jose, CA (US); Thomas A. Piazza, Granite Bay, CA (US)

Correspondence Address: BUCKLEY, MASCHOFF, TALWALKAR LLC, 5 ELM STREET, NEW CANAAN, CT, 06840, US

(21) Appl. No.: 10/879,460

(22) Filed: Jun. 29, 2004

(51) Int. Cl. G06F 15/00

(52) U.S. Cl. 712/234

(57) ABSTRACT

According to some embodiments, a conditional Single Instruction, Multiple Data instruction is provided. For example, a first conditional instruction may be received at an n-channel SIMD execution engine. The first conditional instruction may be evaluated based on multiple channels of associated data, and the result of the evaluation may be stored in an n-bit conditional mask register. A second conditional instruction may then be received at the execution engine and the result may be copied from the conditional mask register to an n-bit wide, m-entry deep conditional stack.

### BACKGROUND

To improve the performance of a processing system, a Single Instruction, Multiple Data (SIMD) instruction may be simultaneously executed for multiple operands of data in a single instruction period. For example, an eight-channel SIMD execution engine might simultaneously execute an instruction for eight 32-bit operands of data, each operand being mapped to a unique compute channel of the SIMD execution engine. In some cases, an instruction may be “conditional.” That is, an instruction or set of instructions might only be executed if a pre-determined condition is satisfied. Note that in the case of a SIMD execution engine, such a condition might be satisfied for some channels while not being satisfied for other channels.

### BRIEF DESCRIPTION OF THE DRAWINGS

FIGS. 1 and 2 illustrate processing systems.

FIGS. 3-5 illustrate a SIMD execution engine according to some embodiments.

FIGS. 6-9 illustrate a SIMD execution engine according to some embodiments.

FIG. 10 is a flow chart of a method according to some embodiments.

FIGS. 11-13 illustrate a SIMD execution engine according to some embodiments.

FIG. 14 is a flow chart of a method according to some embodiments.

FIG. 15 is a block diagram of a system according to some embodiments.

### DETAILED DESCRIPTION

Some embodiments described herein are associated with a “processing system.” As used herein, the phrase “processing system” may refer to any device that processes data. A processing system may, for example, be associated with a graphics engine that processes graphics data and/or other types of media information. In some cases, the performance of a processing system may be improved with the use of a SIMD execution engine. For example, a SIMD execution engine might simultaneously execute a single floating point SIMD instruction for multiple channels of data (e.g., to accelerate the transformation and/or rendering three-dimensional geometric shapes).

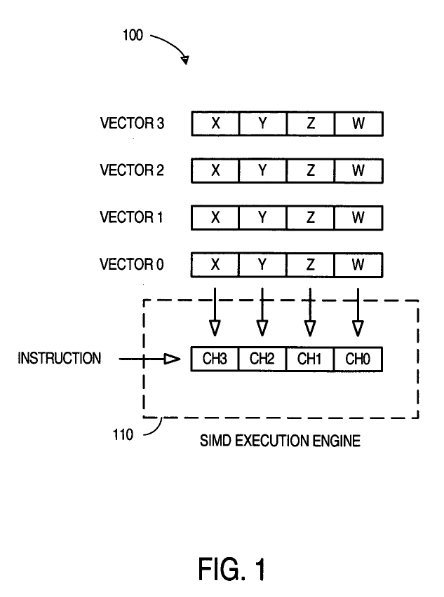

FIG. 1 illustrates one type of processing system 100 that includes a SIMD execution engine 110. In this case, the execution engine receives an instruction (e.g., from an instruction memory unit) along with a four-component data vector (e.g., vector components X, Y, Z, and W, each having bits, laid out for processing on corresponding channels 0 through 3 of the SIMD execution engine 110). The engine 110 may then simultaneously execute the instruction for all of the components in the vector. Such an approach is called a “horizontal” or “array of structures” implementation.

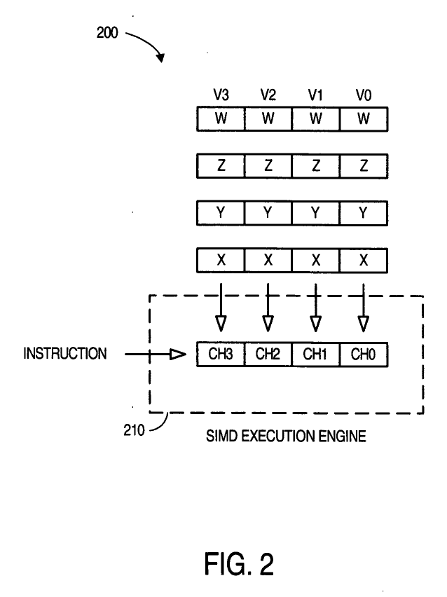

FIG. 2 illustrates another type of processing system 200 that includes a SIMD execution engine 210. In this case, the execution engine receives an instruction along with four operands of data, where each operand is associated with a different vector (e.g., the four X components from vectors 0 through 3). The engine 210 may then simultaneously execute the instruction for all of the operands in a single instruction period. Such an approach is called a “channel-serial” or “structure of arrays” implementation.

Note that some SIMD instructions may be conditional. Consider, for example, the following set of instructions:

```
IF (condition 1)
    first set of instructions
ELSE
    second set of instructions
END IF
```

Here, the first set of instructions will be executed when “condition 1” is true and the second set of instructions will be executed when “condition 1” is false. When such an instruction is simultaneously executed for multiple channels of data, however, different channels may produce different results. That is, the first set of instructions may need to be executed for some channels while the second set of instructions need to be executed for other channels.

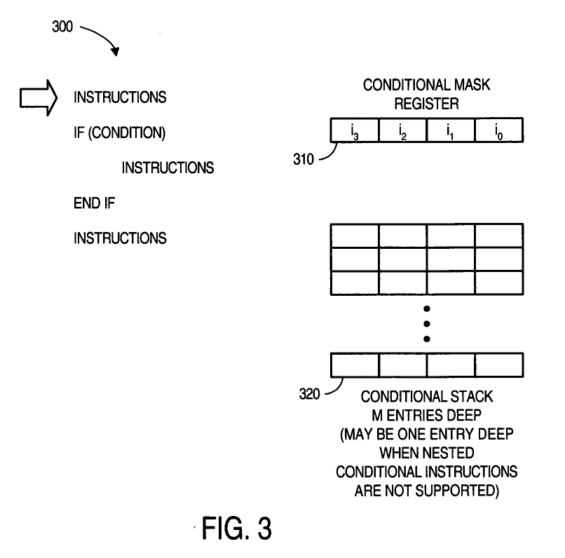

FIGS. 3-5 illustrate an four-channel SIMD execution engine 300 according to some embodiments. The engine 300 includes a four-bit conditional mask register 310 in which each bit is associated with a corresponding compute channel. The conditional mask register 310 might comprise, for example, a hardware register in the engine 300. The engine 300 may also include a four-bit wide, m-entry deep conditional stack 320. The conditional stack 320 might comprise, for example, series of hardware registers, memory locations, and/or a combination of hardware registers and memory locations (e.g., in the case of a ten entry deep stack, the first four entries in the stack 320 might be hardware registers while the remaining six entries are stored in memory). Although the engine 300, the conditional mask register 310, and the conditional stack 320 illustrated in FIG. 3 are associated with four channels, note that implementations may be associated with other numbers of channels (e.g., an x channel execution engine), and each compute channel may be capable of processing a y-bit operand.

The engine 300 may receive and simultaneously execute instructions for four different channels of data (e.g., associated with four compute channels). Note that in some cases, fewer than four channels may be needed (e.g., when there are less than four valid operands). As a result, the conditional mask vector 310 may be initialized with an initialization vector indicating which channels have valid operands and which do not (e.g., operands i₀ through i₃, with a “1” indicating that the associated channel is currently enabled). The conditional mask vector 310 may then be used to avoid unnecessary processing (e.g., an instruction might be executed only for those operands in the conditional mask register 310 that are set to “1”). According to some embodiments, information in the conditional mask register 310 may be combined with information in other registers (e.g., via a Boolean AND operation) and the result may be stored in an overall execution mask register (which may then used to avoid unnecessary or inappropriate processing).

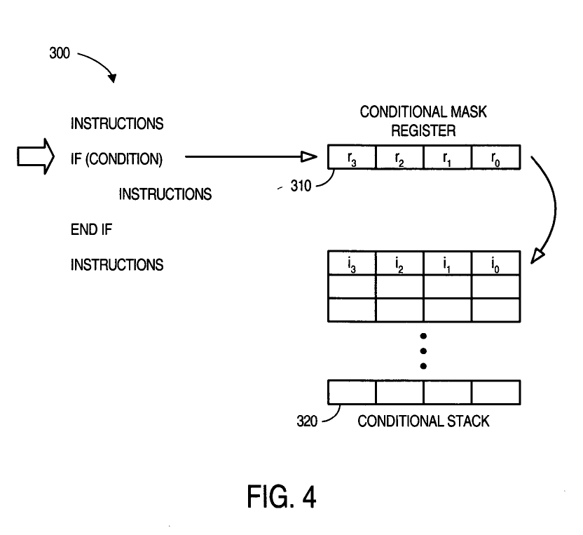

When the engine 300 receives a conditional instruction (e.g., an “IF” statement), as illustrated in FIG. 4, the data in the conditional mask register 310 is copied to the top of the conditional stack 320. Moreover, the instruction is executed for each of the four operands in accordance with the information in the conditional mask register. For example, if the initialization vector was “1110,” the condition associated with an IF statement would be evaluated for the data associated with the three Most Significant operands (MSBs) but not the Least Significant Bit (LSB) (e.g., because that channel is not currently enabled). The result is then stored in the conditional mask register 310 and can be used to avoid unnecessary and/or inappropriate processing for the statements associated with the IF statement. By way of example, if the condition associated with the IF statement resulted in a “110x” result (where x was not evaluated because the channel was not enabled), “1100” may be stored in the conditional mask register 310. When other instructions associated with the IF statement are then executed, the engine 300 will do so only for the data associated with the two MSBs (and not the data associated with the two LSBs).

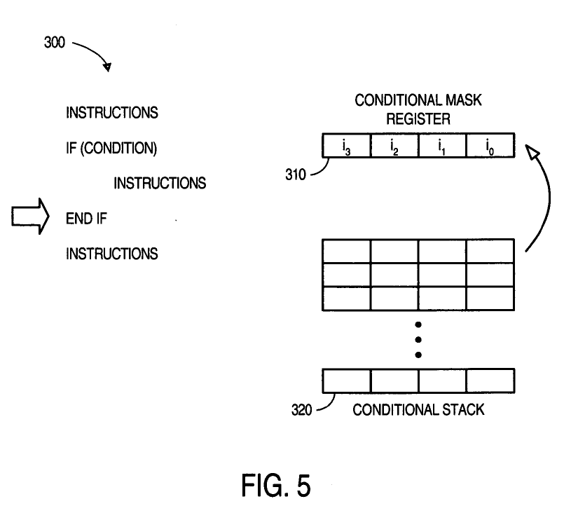

When the engine 300 receives an indication that the end of instructions associated with a conditional instruction has been reached (e.g., and “END IF” statement), as illustrated in FIG. 5, the data at the top of the conditional stack 320 (e.g., the initialization vector) may be transferred back into the conditional mask register 310 restoring the contents that indicate which channels contained valid data prior to entering the condition block. Further instructions may then be executed for data associated with channels that are enabled. As a result, the SIMD engine 300 may efficiently process a conditional instruction.

According to some embodiments, one conditional instruction may be “nested” inside of a set of instructions associated with another conditional instruction. Consider, for example, the following set of instructions:

```
IF (condition 1)
    first set of instructions
    IF (condition 2)
        second set of instructions
    END IF
    third set of instructions
END IF
```

In this case, the first and third sets of instructions should be executed when “condition 1” is true and the second set of instructions should only be executed when both “condition 1” and “condition 2” are true.

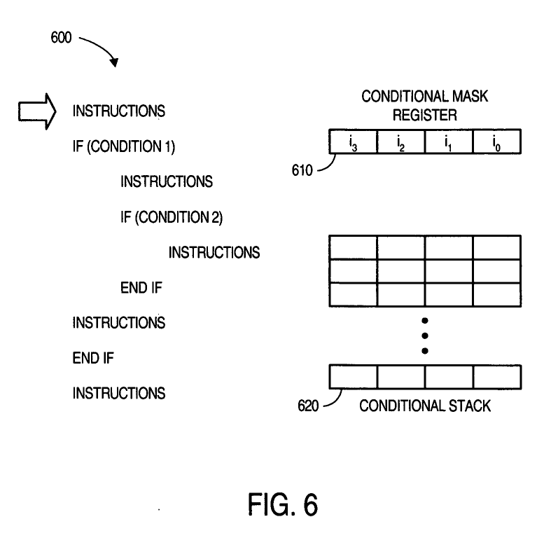

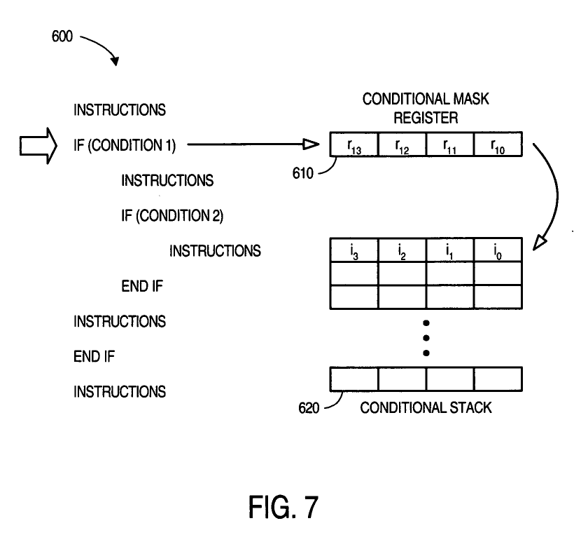

FIGS. 6-9 illustrate a SIMD execution engine 600 that includes a conditional mask register 610 (e.g., initialized with an initialization vector) and a conditional stack 620 according to some embodiments. As before, the information in conditional mask register 610 is copied to the top of the stack 620, and channels of data are evaluated in accordance with (i) the information in the conditional mask register 610 and (ii) the condition associated with the first conditional instruction (e.g., “condition 1”). The results of the evaluation (e.g., r₁₀ through r₁₃) are stored into the conditional mask register 610 when a first conditional instruction is executed (e.g., a first IF statement) as illustrated in FIG. 7. The engine 600 may then execute further instructions associated with the first conditional instruction for multiple operands of data as indicated by the information in the conditional mask register 610.

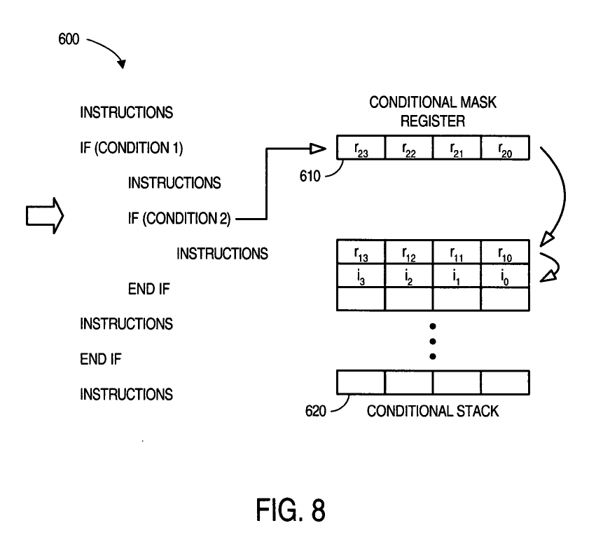

FIG. 8 illustrates the execution of another, nested conditional instruction (e.g., a second IF statement) according to some embodiments. In this case, the information currently in the conditional mask register 610 is copied to the top of the stack 620. As a result, the information that was previously at the top of the stack 620 (e.g., the initialization vector) has been pushed down by one entry. Multiple channels of data are then simultaneously evaluated in accordance with the (i) the information currently in the conditional mask register 610 (e.g., r₁₀ through r₁₃) and the condition associated with the second conditional instruction (e.g., “condition 2”). The result of this evaluation is then stored into the conditional mask register (e.g., r₂₀ through r₂₃) and may be used by the engine 600 to execute further instructions associated with the second conditional instruction for multiple operands of data as indicated by the information in the conditional mask register 610.

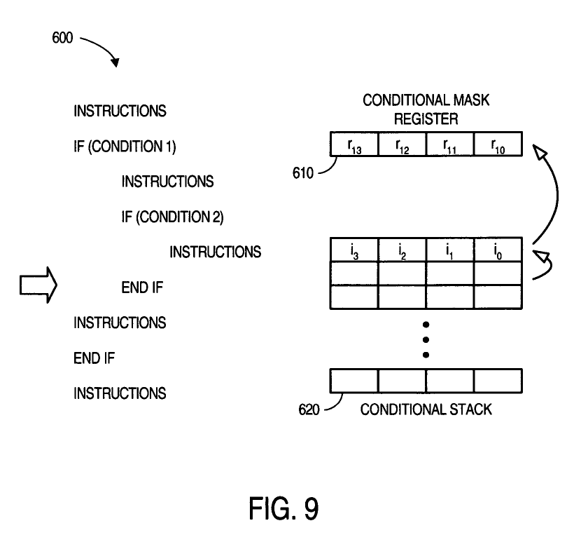

When the engine 600 receives an indication that the end of instructions associated with the second conditional instruction has been reached (e.g., and “END IF” statement), as illustrated in FIG. 9, the data at the top of the conditional stack 620 (e.g., r₁₀ through r₁₃) may be moved back into the conditional mask register 610. Further instructions may then be executed in accordance with the conditional mask register 620. If another END IF statement is encountered (not illustrated in FIG. 9), the initialization vector would be transferred back into the conditional mask register 610 and further instructions may be executed for data associated with enabled channels.

Note that the depth of the conditional stack 620 may be associated with the number of levels of conditional instruction nesting that are supported by the engine 600. According to some embodiments, the conditional stack 620 is only be a single entry deep (e.g., the stack might actually be an n-operand wide register).

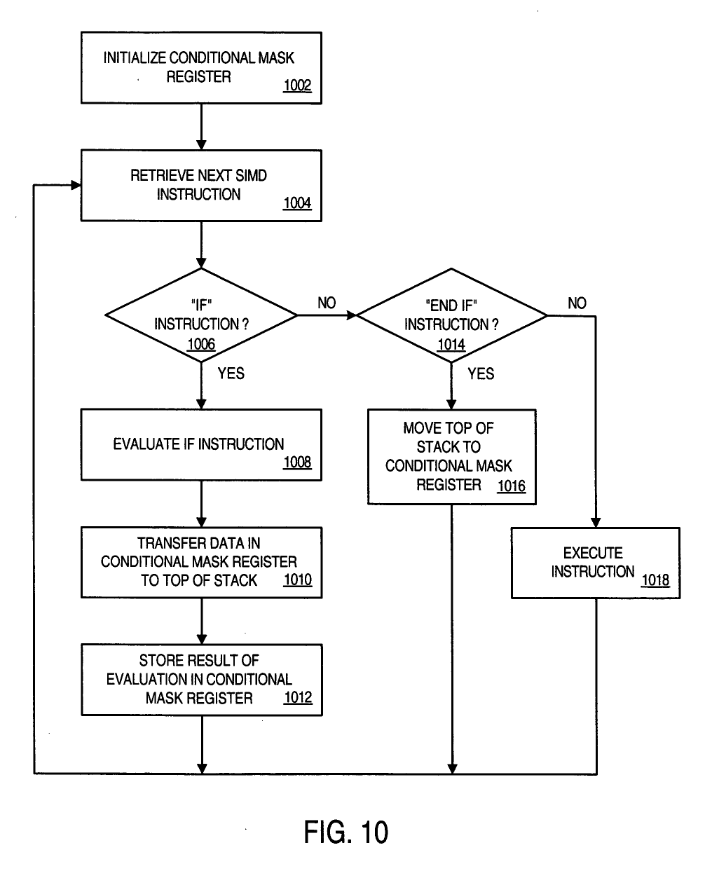

FIG. 10 is a flow chart of a method that may be performed, for example, in connection with some of the embodiments described herein. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 1002, a conditional mask register is initialized. For example, an initialization vector might be stored in the conditional mask register based on channels that are currently enabled. According to another embodiment, the conditional mask register is simply initialized to all ones (e.g., it is assumed that all channels are always enabled).

The next SIMD instruction is retrieved at 1004. For example, a SIMD execution engine might receive an instruction from a memory unit. When the SIMD instruction is an “IF” instruction at 1006, a condition associated with the instruction is evaluated at 1008 in accordance with the conditional mask register. That is, the condition is evaluated for operands associated with channels that have a “1” in the conditional mask register. Note that in some cases, one or none of the channels might have a “1” in the conditional mask register.

At 1010, the data in the conditional mask register is transferred to the top of a conditional stack. For example, the current state of the conditional mask register may saved to be later restored after the instructions associated with the “IF” instruction have been executed. The result of the evaluation is then stored in the conditional mask register at 1012, and the method continues at 1004 (e.g., the next SIMD instruction may be retrieved).

When the SIMD instruction was not an “IF” instruction at 1006, it is determined at 1014 whether or not the instruction is an “END IF” instruction. If not, the instruction is executed 1018. For example, the instruction may be executed for multiple channels of data as indicated by the conditional mask register and the remaining values in the stack are moved up one position.

When it is determined that an “END IF” instruction has been encounter at 1014, to information at the top of the conditional stack is moved back into the conditional register at 1016.

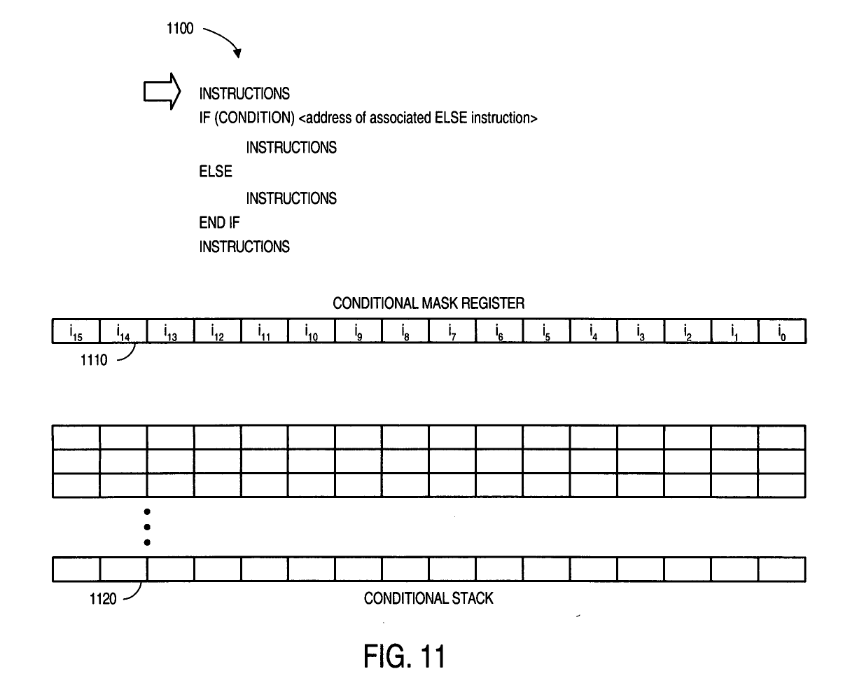

In some cases, a conditional instruction will be associated with both (i) a first set of instructions to be execute when a condition is. true and (ii) a second set of instructions to be execute when that condition is false (e.g., associated with an ELSE statement). FIGS. 11-13 illustrate a SIMD execution engine 1100 according to some embodiments. As before, the engine 1100 includes an initialized conditional mask register 1110 and a conditional stack 1120. Note that in this case, the engine 1100 is able to simultaneously execute an instruction for sixteen operands of data. According to this embodiment, the conditional instruction also includes an address associated with the second set of instructions. In particular, when it is determined that the condition is not true for all operands of data that were evaluated (e.g., for the channels that are both enabled and not masked due to a higher-level IF statement), the engine 1100 will jump directly to the address. In this way, the performance of the engine 1100 may be improved because unnecessary instructions between the IF-ELSE pair may be avoided. If the conditional instruction is not associated with an ELSE instruction, the address may instead be associated with an END IF instruction. According to yet another embodiment, an ELSE instruction might also include an address of an END IF instruction. In this case, the engine 1100 could jump directly to the END IF instruction when the condition is true for every channel (and therefore none of the instructions associated with the ELSE need to be executed).

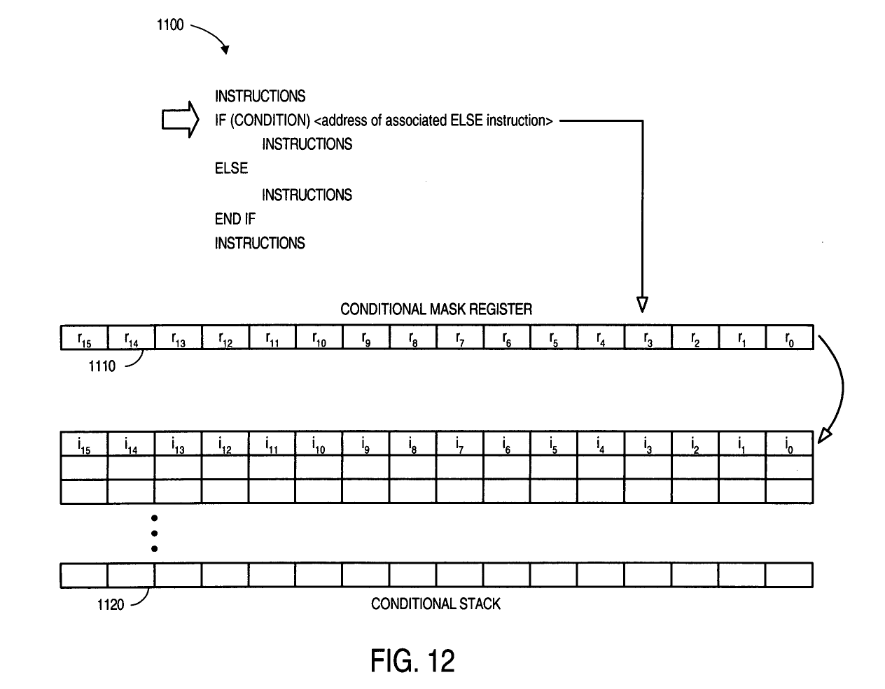

As illustrated in FIG. 12, the information in the conditional mask register 1110 is copied to the conditional stack 1120 when a conditional instruction is encountered. Moreover, the condition associated with the instruction may be evaluated for multiple channels in accordance with the conditional mask register 1110 (e.g., for all enabled channels when no higher level IF instruction is pending), and the result is stored in the conditional mask register 1110 (e.g., operands r₀ through r₁₅). Instructions associated with the IF statement may then be executed in accordance with the conditional mask register 1110.

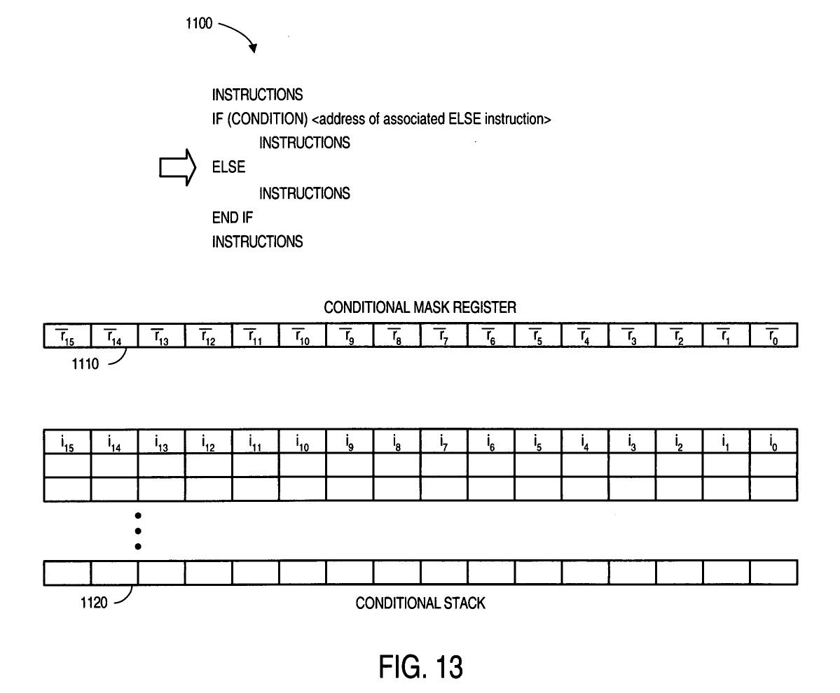

When the ELSE instruction is encountered as illustrated in FIG. 13, the engine 1100 might simply invert all of the operands in the conditional mask register 1110. In this way, data associated with channels that were not executed in connection with the IF instruction would now be executed. Such an approach, however, might result in some channels being inappropriately set to one and thus execute under the ELSE when no execution on those channels should have occurred. For example, a channel that is not currently enabled upon entering the IF-ELSE-END IF code block should be masked (e.g., set to zero) for both the IF instruction and the ELSE instruction. Similarly, a channel that is currently masked because of a higher-level IF instruction should remain masked. To avoid such a problem, instead of simply inverting all of the operands in the conditional mask register 1110 when an ELSE instruction is encountered, the engine 1100 may combine the current information in the conditional mask register 1110 with the information at the top of the conditional stack 1120 via a Boolean, such as new mask=NOT(mask) AND top-of-stack.

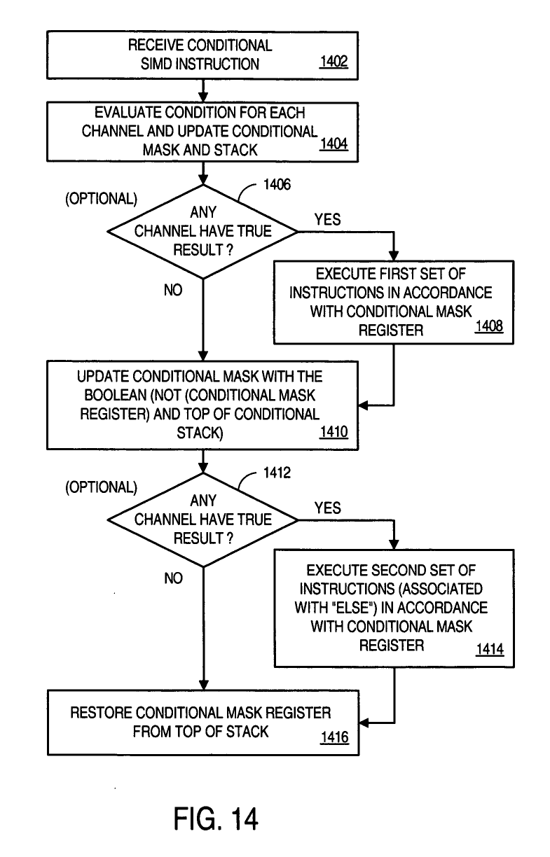

FIG. 14 is a flow chart of a method according to some embodiments. At 1402, a conditional SIMD instruction is received. For example, a SIMD execution engine may retrieve an IF instruction from a memory unit. At 1404, the engine may then (i) copy the current information in the conditional mask register to a conditional stack, (ii) evaluate the condition in accordance with multiple channels of data and a conditional mask register, and (iii) store the result of the evaluation in the conditional mask register.

If any of the channels that were evaluated were true at 1406, a first set of instructions associated with the IF instruction may be executed at 1408 in accordance with the conditional mask register. Optionally, if none of the channels were true at 1406 these instructions may be skipped.

When an ELSE statement is encountered, the information in the conditional mask register may be combined with the information at the top of the conditional stack at 1410 via a per-channel Boolean operation such as NOT(conditional mask register) AND top-of-stack. A second set of instructions may be executed (e.g., associated with an ELSE instruction) may then been executed at 1414, and the conditional mask register may be restored from the conditional stack at 1416. Optionally, if none of the channels were true at 1412 these instructions may be skipped.

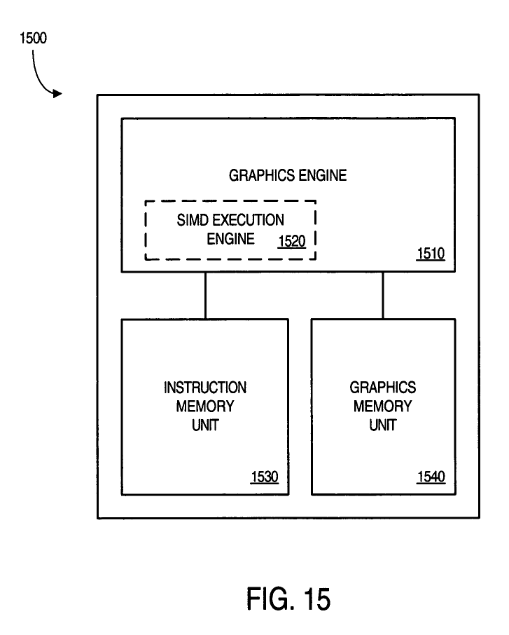

FIG. 15 is a block diagram of a system 1500 according to some embodiments. The system 1500 might be associated with, for example, a media processor adapted to record and/or display digital television signals. The system 1500 includes a graphics engine 1510 that has an n-operand SIMD execution engine 1520 in accordance with any of the embodiments described herein. For example, the SIMD execution engine 1520 might have an n-operand conditional mask vector to store a result of an evaluation of: (i) a first “if” conditional and (ii) data associated with multiple channels. The SIMD execution engine 1520 may also have an n-bit wide, m-entry deep conditional stack to store the result when a second “if” instruction is encountered. The system 1500 may also include an instruction memory unit 1530 to store SIMD instructions and a graphics memory unit 1540 to store graphics data (e.g., vectors associated with a three-dimensional image). The instruction memory unit 1530 and the graphics memory unit 1540 may comprise, for example, Random Access Memory (RAM) units.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although some embodiments have been described with respect to a separate conditional mask register and conditional stack, any embodiment might be associated with only a single conditional stack (e.g., and the current mask information might be associated with the top entry in the stack).

Moreover, although different embodiments have been described, note that any combination of embodiments may be implemented (e.g., both an IF statement and an ELSE statement might include an address). Moreover, although examples have used “0” to indicate a channel that is not enabled according to other embodiments a “1” might instead indicate that a channel is not currently enabled.

The several embodiments described herein are solely for the purpose of illustration. Persons skilled in the art will recognize from this description other embodiments may be practiced with modifications and alterations limited only by the claims.

1. A method, comprising:
receiving a first conditional instruction at an n-operand single instruction, multiple-data execution engine;
evaluating the first conditional instruction based on multiple operands of associated data;
storing the result of the evaluation in an n-bit conditional mask register;
receiving a second conditional instruction at the execution engine; and
copying the result from the conditional mask register to an n-bit wide, m-entry deep conditional stack.

2. The method of claim 1, further comprising:
evaluating the second conditional instruction based on the data in the conditional mask register and multiple operands of associated data;
storing the result of the evaluation of the second conditional instruction in the conditional mask register;
executing instructions associated with the second conditional instruction in accordance with the data in the conditional mask register;
moving the top of the conditional stack to the conditional mask register; and
executing instructions associated with the first conditional instruction in accordance with the data in the conditional mask register.

3. The method of claim 1, wherein the first conditional instruction is associated with (i) a first set of instructions to be executed when a condition is true and (ii) a second set of instructions to be executed when the condition is false.

4. The method of claim 3, wherein the first conditional instruction includes an address associated with the second set of instructions, and further comprising:
jumping to the address when said evaluating indicates that the first conditional instruction is not satisfied for any evaluated bit of associated data.

5. The method of claim 3, further comprising:
executing the first set of instructions;
combining the data in the conditional mask register with the data at the top of the conditional stack via a Boolean operation;
storing the result of the combination in the conditional mask register; and
executing the second set of instructions in accordance with the data in the conditional mask register.

6. The method of claim 1, wherein each of the n-operands of associated data is associated with a channel, and further comprising prior to receiving the first conditional instruction:
initializing the conditional mask register based on channels to be enabled for execution.

7. The method of claim 1, wherein the conditional stack is more than one entry deep.

8. An apparatus, comprising:
an n-bit conditional mask vector, wherein the conditional mask vector is to store results of evaluations of: (i) an “if” instruction condition and (ii) data associated with multiple channels; and
an n-bit wide, m-entry deep conditional stack to store the information that existed in the conditional mask vector prior to the results of the evaluations.

9. The apparatus of claim 8, wherein the information is to be transferred from the conditional stack to the conditional mask vector when an associated “end if” instruction is executed.

10. The apparatus of claim 8, wherein the “if” instruction is associated with (i) a first set of instructions to be executed on operands associated with a true condition and (ii) a second set of instructions to be executed on operands associated with a false condition.

11. The apparatus of claim 10, wherein the “if” instruction includes an address associated with the second set of instructions, and that address is stored in a program counter when results are false for every channel.

12. The apparatus of claim 10, further comprising an engine to: (i) execute the first set of instructions, (ii) combine the information in the conditional mask vector with the information at the top of the conditional stack, (iii) store the result of the combination in the conditional mask vector, and (iv) execute the second set of instructions.

13. The apparatus of claim 8, wherein the conditional mask vector is to be initialized in accordance with enabled channels.

14. The apparatus of claim 8, wherein the conditional stack is 1-entry deep.

15. An article, comprising:
a storage medium having stored thereon instructions that when executed by a machine result in the following:
receiving a first conditional statement at an n-channel single instruction, multiple-data execution engine,
simultaneously evaluating the first conditional statement for multiple channels of associated data,
storing the result of the evaluation in an n-bit conditional mask register,
receiving at the execution engine a second conditional statement, and
copying the result from the conditional mask register to an n-bit wide, m-entry deep conditional stack.

16. The article of claim 15, wherein the first conditional statement: (i) is associated with a first set of statements to be executed when a condition is true, (iii) is associated with a second set of statements to be executed when the condition is false, and (iii) includes an address associated with the second set of statements, and said method further comprises:
jumping to the address when said evaluating indicates that the first conditional statement not true for any of the n-channels of associated data.

17. The article of claim 16, wherein said method further comprises:
evaluating the second conditional statement based on the data in the conditional mask register and n-channels of associated data,
storing the result of the evaluation of the second conditional statement in the conditional mask register,
executing statements associated with the second conditional statement in accordance with the data in the conditional mask register,
transferring the top of the conditional stack to the conditional mask register; and
executing statements associated with the first conditional statement in accordance with the data in the conditional mask register.

18. A system, comprising:
a processor, including:
an n-bit conditional mask vector, wherein the conditional mask vector is to store a result of an evaluation of: (i) a first “if” condition and (ii) data associated with a plurality of channels, and
an n-bit wide, m-entry deep conditional stack to store the result when a second “if” instruction is encountered; and
a graphics memory unit.

19. The system of claim 18, wherein the result is to be transferred from the conditional stack to the conditional mask vector when an “end if” instruction associated with the second “if” instruction is executed.

20. The system of claim 18, further comprising an instruction memory unit.
